(19) United States
(12) Patent Application Publication
(10) Pub. No.: US 2018/0314826 A1
(43) Pub. Date: Nov. 1, 2018

(54) DETECTION OF COMPUTING OPERATIONS USING THERMAL SENSING

(71) Applicant: CA, Inc., New York, NY (US)

(72) Inventor: Serge Mankovskii, Morgan Hill, CA (US)

(21) Appl. No.: 15/499,453

(22) Filed: Apr. 27, 2017

(51) Int. Cl. G06F 21/56; G06N 99/00; G06K 9/62

(52) U.S. Cl. CPC G06F 21/566; G06F 21/567; G06F 2221/034; G06K 9/6215; G06N 99/005

(57) ABSTRACT

Techniques are disclosed relating to detecting computing operations using thermal sensing. In some embodiments, a first computer system may analyze a series of thermal images of a target computer system. In some embodiments, the first computer system may identify, based on the analyzing, a first thermal image pattern from the series of thermal images of the first target computer system. In some embodiments, the first computer system may compare the first thermal image pattern to known thermal image patterns indicative of known computing operations. In some embodiments, the first computer system may provide an output indicative of the comparing.

### BACKGROUND

### Technical Field

This disclosure relates generally to the detection of computing operations, and more specifically to the detection of computing operations using thermal sensing.

### Description of the Related Art

As a computer system performs a computing operation, the temperature of various components of the computer system may vary. This temperature variation may be caused by multiple factors, including the heat generated by the dissipation of power in the various components. For example, heat may be generated by a processor subsystem of the computer system due to Joule heating, in which the flow of electrical current through conductors of the processor subsystem generates heat. In various situations, it may be desirable to detect the heat emitted by a computer system.

### SUMMARY

Techniques are disclosed relating to the detection of computing operations using thermal sensing. In various embodiments, a first computer system may receive thermal images of a target computer system. For example, in some embodiments, the target computer system may be one of many computer systems operating in a datacenter facility. The first computer system may analyze a series of thermal images of the target computer system. In some embodiments, the first computer system may identify, based on the analyzing, a first thermal image pattern from the series of thermal images of the first target computer system. The first computer system may compare the first thermal image pattern to known thermal image patterns indicative of known computing operations. Further, the first computer system may provide an output indicative of the comparing. For example, in some embodiments, the first computer system may provide an output indicative of potential malicious activity on the target computer system. Additionally, in some embodiments, the first computer system may determine whether the first thermal image pattern indicates that the first target computer system is performing computing operations other than those associated with an idle state.

### BRIEF DESCRIPTION OF THE DRAWINGS

FIG. 1 is a block diagram illustrating an example system for detecting computing operations using thermal sensing, according to some embodiments.

FIG. 2 is a block diagram illustrating an example configuration of an activity monitor of a monitoring computer system, according to some embodiments.

FIG. 3A is a block diagram illustrating an example thermal image pattern, according to some embodiments.

FIG. 3B is a block diagram illustrating example known thermal image patterns, according to some embodiments.

FIG. 4 is a flow diagram illustrating an example method for detecting computing operations using thermal sensing, according to some embodiments.

FIG. 5 is a flow diagram illustrating an example method for detecting computing operations on a target computer system based on thermal sensing, according to some embodiments.

FIG. 6 is a flow diagram illustrating an example method for detecting computing operations using thermal sensing, according to some embodiments.

FIG. 7 is a block diagram illustrating an example computer system that may be used to implement one or more of the components in a system for detecting computing operations using thermal sensing, according to some embodiments.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a computer system that runs six applications, the terms “first application” and “second application” can be used to refer to any two of the six applications, and not, for example, just a first two applications to be started.

When used in the claims, the term “or” is used as an inclusive or and not as an exclusive or. For example, the phrase “at least one of x, y, or z” means any one of x, y, and z, as well as any combination thereof (e.g., x and y, but not z).

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION

A monitoring computer system is disclosed herein that detects computing operations being performed on a target computer system. Using thermal sensing, according to various embodiments, the monitoring computer system may receive a series of thermal images of a target computer system. The monitoring computer system may analyze the series of thermal images to identify a thermal image pattern associated with the series of thermal images. The monitoring computer system may then compare the thermal image pattern to known thermal image patterns associated with benign computing operations and generate an output indicative of this comparison.

The systems and methods disclosed herein that detect computing operations being performed by a target computer system using thermal sensing may provide various advantages, for example, in situations in which it may be undesirable or impractical to monitor the computing operations being performed by a target computer system through more direct methods, such as computer-monitoring software.

For example, a target computer system may be one of many computer systems operating in a datacenter facility, according to some embodiments. In such embodiments, the computer systems operating in the datacenter facility may belong to or provide services for various entities, for example as part of a software as a service (SaaS) model. In these embodiments, it may be desirable to provide administrative services, such as malicious activity detection, for some or all of the computer systems operating in the datacenter facility, regardless of the particular entity for which the computer systems are being used. As used herein, the terms “malicious activity” or “malicious computing operation” are to be understood according to their ordinary meaning in the art, which includes any software program or portion of code operable to disable, disrupt, monitor, or otherwise interfere with computing operations being performed by a computer system. In some embodiments, malicious computing operations may include various forms of malware, such as viruses, spyware, adware, Trojans, worms, or any other malicious or unwanted software program or portion of code. However, in providing these administrative services, such as malicious activity-detection, it may be computationally expensive, and therefore impractical, for the service provide to directly monitor the computing operations being performed by the computer systems of the datacenter facility. Further, direct monitoring by the service provider may be undesirable or infeasible, for example, due to privacy or security concerns. Thus, in various embodiments, it may be desirable to perform malicious activity-detection using thermal sensing.

Additionally, in some embodiments, it may be desirable to monitor the computing operations performed by target computer system 108 using thermal sensing to determine whether the target computer system 108 is currently in use. For example, in some embodiments, a datacenter facility may include a large number of computer systems, such as 20,000 or more computer systems. In such embodiments, some computer systems may be in use, for example hosting a software application for an entity. Other computer systems in the datacenter facility, however, may not be in use, rather merely operating in an idle state. In such embodiments, it may be desirable to identify which computer systems of the datacenter facility are currently in use and which are not, for example to perform maintenance or conserve electrical power by turning off those computer systems that are not in use. This distinction may not be readily ascertainable by a technician physically present in the datacenter facility, however. Further, it may be impractical for the technician to directly monitor the activity of a given computer system, for example using computer-monitoring software. Thus, in such embodiments, it may be desirable to monitor the computing operations being performed by the computer systems of the datacenter facility using thermal sensing.

Note that these described embodiments are provided merely as examples and are not intended to limit the scope of this disclosure. The disclosed systems and methods could be implemented in other environments, for example in a standalone computing system, without departing from the scope of the present disclosure.

The disclosed systems and methods may provide various improvements to the functioning of the target computer system and the monitoring computer system, as well as improve the operation of a datacenter facility as a whole, particularly as it relates to detecting malicious computing operations. For example, in some instances, a target computer system may rely on anti-malware software in order to detect malicious computing operations. In some instances, however, a malicious computing operation, such as a computer virus, may conceal its presence from anti-malware software. Consequently, in such an instance, a computer system relying solely on anti-malware software to detect malicious computing operations may be susceptible to continued exposure. In various instances, however, the computer virus may not be configured to conceal its presence from the described systems and methods for detecting computer operations using thermal sensing. Thus, the disclosed systems and methods may be used to detect malicious computing operations, such as computer viruses or other malware, which may otherwise go unnoticed. Additionally, the systems and methods described herein may be configured to detect computing operations being performed on various computer systems, regardless of the particular manufacturer of the processor subsystem. Further, unlike conventional anti-malware software, the systems and methods described herein may, in some embodiments, not rely on a target computer system to monitor itself for malicious computing operations. This feature may be advantageous because, as noted above, some malware may conceal its presence from the anti-malware software running on the target computer. But by monitoring the computing operations of a target computer system using thermal imaging, the malware may still be detected.

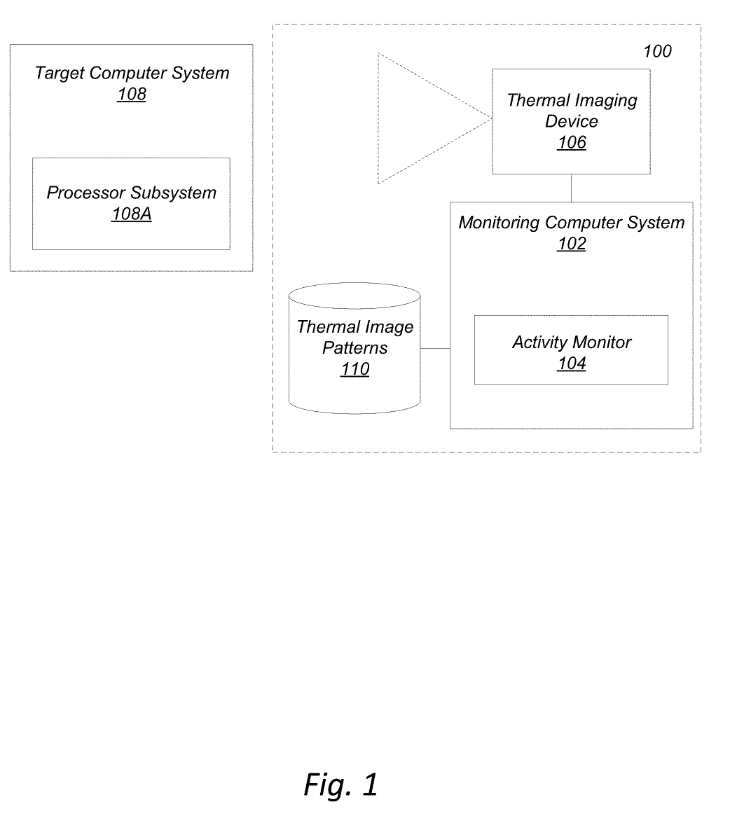

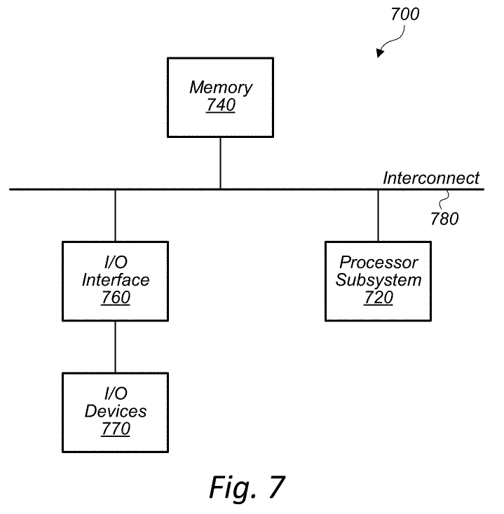

This disclosure initially describes, with reference to FIGS. 1-6, example systems and methods for detecting computing operations using thermal sensing, according to various embodiments. Finally, an example computer system is described with reference to FIG. 7.

Referring now to FIG. 1, a block diagram illustrating an example system 100 for detecting computing operations using thermal sensing is depicted. In the illustrated embodiment, system 100 includes a monitoring computer system 102, a thermal imaging device 106, thermal image patterns 110, and target computer system 108. Note that, although only one target computer system 108 is shown, system 100 may include any number of target computer systems. For example, in one embodiment, target computer system 108 may be one of many computer systems operating in a datacenter facility.

As shown in FIG. 1, target computer system 108 may include processor subsystem 108A, which may be used to perform various computing operations. For example, in one embodiment, target computer system 108 may be a server computer system operating in a datacenter facility, configured to perform various computing operations to serve client requests using processor subsystem 108A.

As will be appreciated by those skilled in the art, the temperature of processor subsystem 108A may vary as it performs computing operations. This temperature variation may be caused by multiple factors, including the heat generated by the dissipation of power by processor subsystem 108A as it performs computing operations. For example, heat may be generated in processor subsystem 108A due to Joule heating, in which the flow of electrical current through conductors of processor subsystem 108A generates heat. This heat may be emitted as thermal radiation, which may be detected by a thermal imaging device such as, for example, thermal imaging device 106. In various embodiments, thermal imaging device 106 may include any suitable device for capturing thermal images, including, for example, infrared cameras or sensors configured to detect infrared radiation.

In various embodiments, the thermal characteristics of processor subsystem 108A may vary over the course of a given computing operation. As used herein, the term “thermal characteristics” refers generally to heat-related properties, including the intensity and distribution of thermal radiation emitted by an object. For example, during an initial phase of the given computing operation, power may be dissipated primarily in a first region of processor subsystem 108A, which may cause target computer system 108 to emit thermal radiation according to a first intensity and distribution. During a subsequent phase of the given computing operation, power may be dissipated primarily in a second region of processor subsystem 108A, which in turn may cause target computer system 108 to emit thermal radiation according to a second intensity and distribution. This variation in power dissipation and resultant thermal radiation may continue as processor subsystem 108A performs the given computing operation. In various embodiments, by capturing thermal images of processor subsystem 108A as it performs the given computing operation, a thermal image pattern may be associated with the given computing operation. In various embodiments, a thermal image pattern may correspond to computing operations being performed by the target computer system 108, for example during the time period during which the thermal images of the thermal image pattern were captured. Further, in some embodiments, processor subsystem 108A may dissipate power in a similar manner while performing the same given computing operation at a subsequent time. Accordingly, in such embodiments, thermal images captured of processor subsystem 108A as it performs the given computing operation may exhibit a similar thermal image pattern.

In various embodiments, the thermal characteristics of processor subsystem 108A may vary between different computer operations. For example, in some embodiments, processor subsystem 108A may be configured to perform various computing operations. While performing a first computing operation, such as hosting a software application for a remote client, for example, processor subsystem 108A may dissipate heat according to a first pattern of intensity and distribution. Accordingly, thermal images captured of target computer system 108 as it performs the first computing operation may exhibit a first thermal image pattern. While performing a second computing operation, such as performing a data-backup operation, for example, processor subsystem 108A may dissipate heat according to a second pattern of intensity and distribution. Accordingly, thermal images captured of target computer system 108 as it performs the second computing operation may exhibit a second thermal image pattern, which, according to various embodiments, may be different from the first thermal image pattern.

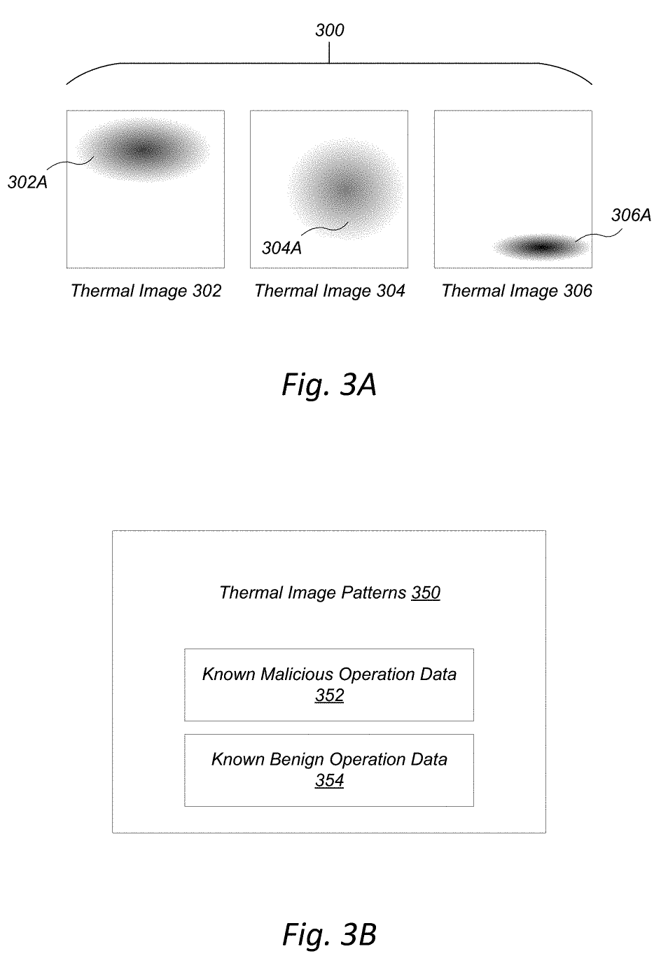

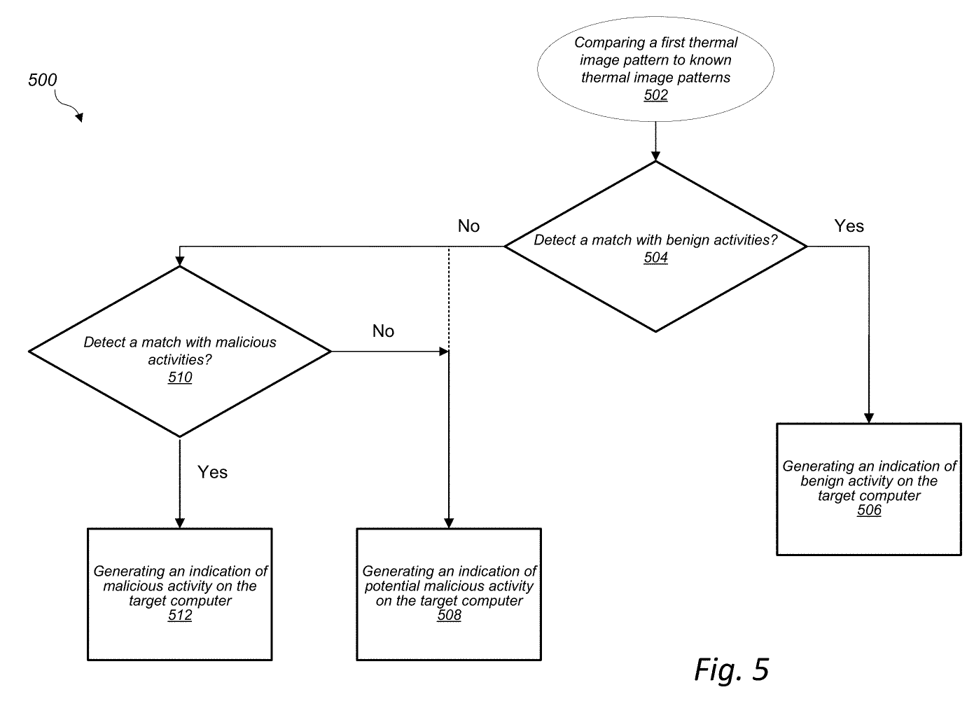

Thermal image patterns associated with computing operations, such as the first thermal image pattern associated with the first computing operation, may be stored, for example as thermal image patterns 110. As described in more detail below with reference to FIG. 5, monitoring computer system 102 may be configured to compare a captured thermal image pattern with thermal image patterns associated with known computing operations to detect computing operations being performed by target computer system 108 using thermal sensing. As used herein, the term “known computing operations” refers to computing operations for which an associated thermal image pattern is accessible to monitoring computer system 102. As explained in more detail below with reference to FIG. 3B, known computing operations may in some cases be classified as “known benign computing operations” or “known malicious computing operations.” As used herein, the terms “known benign computing operations” or “known benign activity” refer to any software program or portion of code classified as being associated with normal or expected computing activity, and not to refer to known malicious computing operations.

Turning briefly to FIG. 3A, a thermal image pattern 300 is shown. As shown in FIG. 3A, thermal image pattern 300 includes thermal images 302-306 depicting thermal characteristics 302A-306A, respectively. In some embodiments, thermal image pattern 300 may include thermal images 302-306 of processor subsystem 108A captured by thermal imaging device 106 while processor subsystem 108A performs a particular computing operation. As shown in FIG. 3A, the thermal images 302-306 included in thermal image pattern 300 may, in some embodiments, depict different thermal characteristics 302A-306A. For example, the intensity and distribution of thermal radiation emitted by processor subsystem 108A may vary as it performs a computing operation. Accordingly, in some embodiments, the thermal images 302-306 of processor subsystem 108A captured while it performs the computing operation may also depict varying thermal characteristics 302A-306A.

In various embodiments, thermal image pattern 300 may be used to detect the computing operations being performed by target computer system 108. For example, as explained in more detail below with reference to FIG. 5, monitoring computer system 102 may compare thermal image pattern 300 with thermal image patterns associated with known computing operations. Based on this comparison, monitoring computer system 102 may determine whether thermal image pattern 300 corresponds to a thermal image pattern associated with a known computing operation and, accordingly, whether target computer system 108 is performing a known computing operation.

Note that, although only three thermal images 302-306 are shown in FIG. 3A, thermal image pattern 300 may include any suitable number of thermal images. In various embodiments, thermal image pattern 300 may include any number of thermal images sufficient to detect a computing operation based on the thermal image pattern.

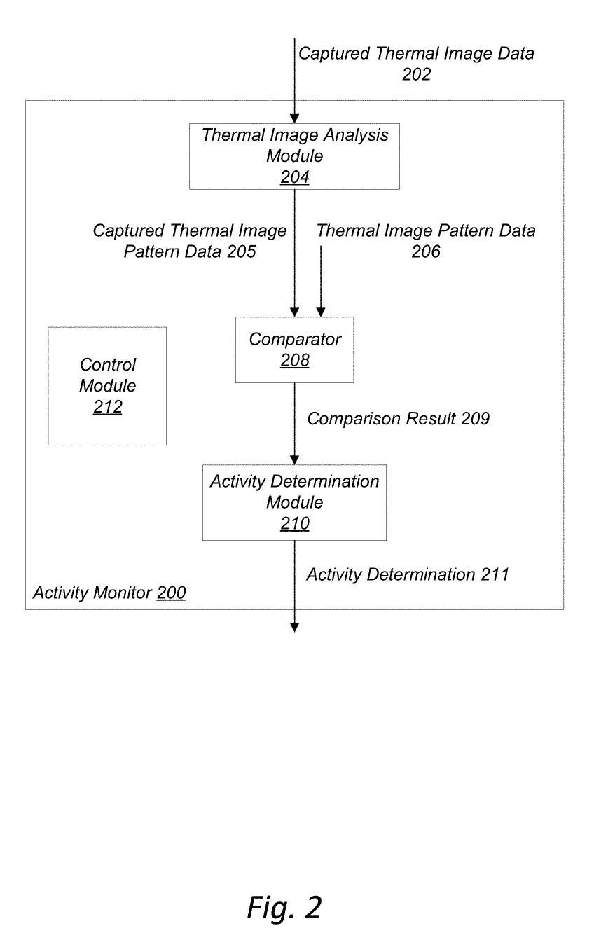

Returning to FIG. 1, system 100 further includes monitoring computer system 102, thermal imaging device 106, and thermal image patterns 110. Note that, although shown as a single system in FIG. 1, system 100 may be implemented as separate systems and/or components operating together. Further, monitoring computer system 102 may include activity monitor 104, as described in more detail with reference to FIG. 2. In various embodiments, activity monitor 104 may be configured to detect computing operations performed by target computer system 108 using thermal sensing. For example, in some embodiments, activity monitor 104 may be configured to monitor computing operations being performed on target computer system 108 by using thermal imaging device 106 to detect changes in the thermal characteristics of processor subsystem 108A. Note, however, that in other embodiments, activity monitor 104 may be configured to monitor computing operations being performed on target computer system 108, not in response to detecting a change in thermal characteristics, but rather in response to a user request, according to a schedule, etc.

Activity monitor 104 may capture, via thermal imaging device 106, a thermal image pattern of the thermal characteristics of processor subsystem 108A as it performs a given computing operation. In various embodiments, a thermal image pattern, such as thermal image pattern 300 of FIG. 3A, may be captured according to various techniques. For example, in some embodiments, monitoring computer system 102 may monitor target computer system 108 while it is operating in an idle state.

As used herein, the term “idle state” refers to a mode in which the computer system is operating below its normal capacity. For example, an administrator or program might place a computer system in an idle state by disabling a particular set of automatic background operations on the target computer system. Note that a computer system in an idle state may nonetheless be performing unknown (e.g., malicious) computing operations. Thus, placing a computer system into an idle state may simply involve reducing the computing operations being performed, but does not connote an absence of all computing activity. Target computer system 108 may operate in an idle state for various reasons. For example, in some embodiments, target computer system 108 may perform operations according to a schedule, which may include a period of time specifying that the target computer system 108 operate in an idle state. Further, target computer system 108 may be controlled to operate in an idle state, according to some embodiments. For example, a user using target computer system 108 may place it in an idle state. Further, in some embodiments, monitoring computer system 102 may control target computer system 108 to operate in an idle state. In such embodiments, monitoring computer system 102 may control target computer system 108, for example, in response to a user request. In other such embodiments, however, monitoring computer system 102 may be configured to automatically control target computer system 108 to operate in an idle state as part of the monitoring process. In some embodiments, monitoring computer system 102 may send one or more instructions to target computer system 108 that are operable to cause the target computer system to be put in an idle state before the thermal images of target computer system 108 are captured. Further, in some embodiments, the one or more instructions may be operable to disable tasks that are set to be run automatically on target computer system 108.

In some embodiments, activity monitor 104 may be configured to capture, via thermal imaging device 106, one or more thermal images of target computer system 108 in response to detecting a change in thermal characteristics of the target computer system 108, for example in response to detecting a change beyond a particular threshold. In one embodiment, for example, activity monitor 104 may be configured to capture a thermal image of target computer system 108 using thermal imaging device 106 in response to detecting a change in the thermal characteristics of target computer system 108 beyond a particular threshold. For example, thermal imaging device 106 may be configured to take a thermal image of target computer system 108 upon detecting a one-degree Fahrenheit variation in the temperature of any region of processor subsystem 108A. Note, however, that this particular threshold is provided merely as an example, and any suitable variation in the intensity or distribution of heat may be used as the particular threshold, according to various embodiments. In various embodiments, thermal imaging device 106 may be configured to capture thermal images of target computer system 108 during a time period associated with the change in thermal characteristics of processor subsystem 108A.

In other embodiments, activity monitor 104 may be configured to capture thermal images of target computer system 108 at any desired point in time, and not necessarily in response to detecting a change in thermal characteristics of the target computer system 108. For example, in some embodiments, activity monitor 104 may be configured to capture thermal images of target computer system 108 in response to a user-initiated instruction to monitor target computer system 108 using thermal sensing. In other embodiments, activity monitor 104 may be configured to capture thermal images of target computer system 108 according to a schedule, capturing a particular number of images over a given period of time. For example, activity monitor 104 may be configured to capture ten thermal images per second during a five-minute period each day, in one embodiment. In another embodiment, activity monitor may be configured to capture video of the target computer system 108 and generate thermal image pattern 300 by selecting a still image from that video at a particular rate to capture thermal images 302-306.

As noted above, in some embodiments, target computer system 108 may be one of many computer systems operating within a datacenter facility. In such embodiments, thermal images of one or more of the computer systems may be captured according to various techniques. For example, in one embodiment, one or more thermal imaging devices, such as thermal image device 106, may be mounted at various points within the datacenter facility, such as on one or more racks used to house the computer systems. Further, in one embodiment, a thermal imaging device may be mounted to an autonomous or remotely-controlled apparatus, such as a vehicle or drone. In such an embodiment, the autonomous or remotely-controlled apparatus may be configured to navigate to and capture thermal images of one or more of the computer systems in the datacenter facility. In various embodiments, thermal imaging device 106 may capture thermal images of target computer system 108 either individually or of a plurality of target computer systems 108 in a given image. For example, in some embodiments, thermal imaging device 106 may capture thermal images of an entire rack of computing systems operating in a datacenter facility. The captured thermal images may be transmitted to activity monitor 104 for use in identifying computing operations being performed by one or more of the computer systems in the datacenter facility. Note that the thermal images of target computer system 108 may be used by monitoring computer system 102 at any point in time, in various embodiments. That is, monitoring computer system 102 may use the thermal images to detect computing operations contemporaneous with or soon after the thermal images are captured. In other embodiments, however, monitoring computer system 102 may use the thermal images in a “batch” manner, using thermal images of a plurality of target computer systems 108 to detect computing operations thereon at any point in time after the thermal images are captured.

As explained in more detail below with reference to FIG. 5, activity monitor 104 may compare captured thermal image patterns with thermal image patterns corresponding to known computing operations, according to various embodiments. Based on this comparison, activity monitor 104 may determine whether a captured thermal image, such as thermal image pattern 300, for example, corresponds to a thermal image pattern associated with a known computing operation and, accordingly, whether target computer system 108 is performing a known computing operation. Activity monitor 104 may be configured to then generate an output indicative of the result of this comparison. In some embodiments, for example, activity monitor 104 may be configured to generate an output indicative of potential malicious activity on target computer system 108 in response to not detecting a match between the thermal image pattern 300 and any of the thermal image patterns 110 corresponding to known computing operations.

Turning now to FIG. 2, a block diagram of an example activity monitor 200 is shown, according to some embodiments. As shown in FIG. 2, activity monitor 200 includes various modules configured to perform designated functions discussed in more detail below.

As used herein, the term “module” refers to circuitry configured to perform specified operations or to physical non-transitory computer readable media that stores information (e.g., program instructions) that instructs other circuitry (e.g., a processor) to perform specified operations. Such circuitry may implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

In the embodiment depicted in FIG. 2, activity monitor 200 includes thermal image analysis module 204, comparator 208, activity determination module 210, and control module 212. In some embodiments, activity monitor 200 may be implemented, for example, as activity monitor 104 of FIG. 1 and be configured to detect computer operations performed on target computer system 108 using thermal sensing.

As shown in FIG. 2, activity monitor 200 may include thermal image analysis module 204. In various embodiments, thermal image analysis module 204 may be configured to analyze captured thermal image data 202, which may correspond to one or more thermal images captured via thermal imaging device 106 of target computer system 108, and identify one or more thermal image patterns included in the captured thermal image data 202. In some embodiments, the thermal image patterns may correspond to patterns in the variation of intensity and distribution of heat depicted in the thermal images of target computer system 108 included in captured thermal image data 202. Thus, in some embodiments, thermal image analysis module 204 may be configured to analyze the captured thermal image data 202, identify one or more thermal image patterns from the captured thermal image data 202, and generate thermal image pattern data 205 indicative of those one or more thermal image patterns.

Activity monitor 200 also includes comparator 208. In various embodiments, comparator 208 may be configured to compare captured thermal image pattern data 205 with thermal image pattern data 206 and return a comparison result 209. As noted above, thermal image patterns may be associated with a corresponding computing operation being performed by a computer system. These thermal image patterns may be stored, for example as thermal image pattern data 206, for use in identifying a computing operation being performed by a target computer system 108. Thermal image pattern data 206 may include, as described further below in reference to FIG. 3B, thermal image pattern data corresponding to both known malicious computing operations and known benign computing operations. In various embodiments, comparison result 209 may indicate whether captured thermal image pattern data 205 matches any of the thermal image patterns associated with known malicious or known benign computing operations.

As will be appreciated by one of ordinary skill in the art with the benefit of this disclosure, the thermal image patterns associated with a particular computing operation may include variations. In some embodiments, such variations may be due to variations in the thermal conditions of the environment in which target computer system 108 is operating. For example, the thermal characteristics of target computer system 108 may vary due to a number of factors, such as the ambient temperature surrounding target computer system 108, the amount of light (if any) incident upon target computer system 108 at the time the thermal images are captured, the residual heat caused by the performance of previous computing operations, etc. Various techniques may be employed to minimize such variations in the thermal conditions of target computer system 108's operating environment while thermal images are captured. For example, in embodiments in which target computer system 108 is operating in a datacenter facility, various temperature-control techniques may be used, such as using air conditioning units to maintain an ambient temperature within a predetermined range (e.g., 70-80° F.), cold-aisle rack configuration, heat ducts, etc. In addition, other techniques, such as capturing the thermal images at night, shielding the target computer systems 108 from heat generated by air conditioning units, capturing the thermal images while the target computer systems 108 are operating in an idle state, etc. may also be employed.

Further, in some embodiments, variations in the thermal image patterns associated with a particular computing operation may be due to variations in the manner in which target computer system 108 performs the given computing operation. In some embodiments, for example, the performance of a particular computing operation by target computer system 108 may vary due to the starting conditions of the target computer system 108 when it performs the particular computing operation. For example, to perform the particular computing operation, processor subsystem 108A may be required to retrieve one or more instructions from a memory of the target computer system 108. This retrieval of the one or more instructions will result in the dissipation of heat within processor subsystem 108A, affecting the thermal image pattern associated with that instance of the particular computing operation. If, however, the one or more instructions are already stored in a cache of the processor subsystem 108A, processor subsystem 108A may not be required to retrieve the instructions from memory, which in turn may affect the thermal image pattern associated with that instance of the particular computing operation. In view of these potential variations in thermal image patterns associated with the same computing operation, comparator 208 may be configured to indicate a match between the captured thermal image pattern data 205 and one of the thermal image patterns included in thermal image pattern data 206 based on the thermal image patterns being within a specified threshold of similarity to each other.

Activity monitor 200 may further include activity determination module 210. In various embodiments, activity determination module 210 may be configured to generate an activity determination 211 based on comparison result 209. As described in more detail below with reference to FIG. 5, activity determination 211 may specify that the captured thermal image pattern data 205 indicates, according to some embodiments, benign activity on target computer system 108, potential malicious activity on target computer system 108, or malicious activity on target computer system 108. Additionally, in various embodiments, activity determination 211 may indicate whether the target computer system is in use, e.g., performing computing operations other than those associated with an idle state.

As shown in FIG. 2, activity monitor 200 may further include control module 212, which, in various embodiments, may be configured to communicate with and control various components of system 100, such as thermal imaging device 106 or target computer system 108. For example, in various embodiments, control module 212 may be configured to monitor target computer system 108 using thermal imaging device 106. Control module 212 may be configured to control thermal imaging device 106 to capture one or more thermal images of target computer system 108 and, particularly, processor subsystem 108A. In some embodiments, for example, control module 212 may be configured to control thermal imaging device 106 to capture one or more thermal images of target computer system 108 in response to detecting a change in the thermal characteristics of target computer system 108. As noted above, however, in other embodiments, control module 212 may be configured to control thermal imaging device 106 to capture thermal images of one or more target computer systems 108 according to a particular schedule, in response to a user request, etc.

Additionally, in some embodiments, control module 212 may be configured to communicate with and control target computer system 108. For example, as explained above in reference to FIG. 1, control module 212 may be configured to control target computer system 108 to enter into an idle state, according to some embodiments.

Referring now to FIG. 3B, a block diagram of example thermal image patterns 350 is shown, according to some embodiments. Thermal image patterns 350 may be included, for example, in thermal image patterns 110 of FIG. 1. As shown in FIG. 3B, thermal image patterns 350 may include known malicious operation data 352 and known benign operation data 354.

Thermal image patterns 350 may be obtained according to various techniques. For example, in some embodiments, monitoring computer system 102 of FIG. 1 may be configured to store data associated with thermal image patterns according to a machine-learning procedure. In such embodiments, monitoring computer system 102 may be configured to analyze captured thermal images to identify a thermal image pattern. As described in more detail below, monitoring computer system 102 may further be configured to compare the captured thermal image pattern to known thermal image patterns, such as thermal image patterns 350. If, however, the captured thermal image pattern does not match any of the known thermal image patterns, this may indicate that the captured thermal image pattern may correspond to a yet-to-be identified computing operation. For example, the captured thermal image pattern may correspond to a computing operation for which there is not yet a known thermal image pattern 350. In such embodiments, monitoring computer system 102 may be configured to receive, for example from a user, an identification of a known computing operation associated with the captured thermal image pattern. In such embodiments, monitoring computer system 102 may store information corresponding to the known computing operation, such as its associated thermal image pattern and other identifying information, as part of thermal image patterns 350.

Known malicious operation data 352 may include, in various embodiments, data corresponding to thermal image patterns associated with malicious computing operations. For example, in some embodiments, monitoring computer system 102 of may capture thermal images associated with an unknown computing operation and generate a thermal image pattern associated with that unknown computing operation. In such embodiments, the unknown computing operation may be specified, for example by a user of monitoring computer system 102, as a particular computer virus. Monitoring computer system may then store data associated with the particular virus, such as its associated thermal image pattern and other identifying information, as part of known malicious operation data 352. Accordingly, when activity monitor 200 compares subsequent captured thermal image data 205 with thermal image pattern data 206, activity monitor 200 will therefore compare the captured thermal image pattern data 205 to the thermal image pattern associated with the particular computer virus, according to some embodiments.

Note, however, that this is merely one manner in which known malicious operation data 352 may be acquired. In some embodiments, thermal image patterns associated with malicious computing operations may be stored and shared between parties. For example, known malicious operation data 352 for a first monitoring computer system may include thermal image patterns associated with malicious computing operations detected and identified by a separate monitoring computer system, potentially at a remote location.

These described techniques may provide various improvements to the functioning of the monitoring computer system. For example, the thermal image patterns associated with malicious computing operations may be disseminated to various monitoring computer systems. In this way, once a particular form of malicious computing operation is detected on a single computer, for example at a first datacenter facility, the thermal image pattern associated with that particular malicious computing operation may be sent to, for example, a second datacenter facility. The monitoring computer system at the second datacenter facility may then prospectively monitor the computer systems in that datacenter facility for the particular malicious computing operation.

Thermal image patterns 350 may further include known benign operation data 354, which in turn may include data corresponding to thermal image patterns associated with benign computing operations. For example, in some embodiments, monitoring computer system 102 may capture thermal images associated with an unknown computing operation and generate a thermal image pattern associated with that unknown computing operation. In such embodiments, the unknown computing operation may be specified, for example by a user of monitoring computer system 102, as a benign computing operation, such as hosting a software application. Monitoring computer system may then store data associated with the particular computing operation, such as its associated thermal image pattern and other identifying information, as part of known benign operation data 354. Accordingly, when activity monitor 200 compares subsequent captured thermal image data 205 with thermal image pattern data 206, activity monitor 200 will therefore compare the captured thermal image pattern data 205 to the thermal image pattern associated with the benign computing operation, according to some embodiments. Further, as discussed above, thermal image patterns associated with benign computing operations may also be stored and shared between parties. For example, known benign operation data 354 for a first monitoring computer system may include thermal image patterns associated with benign computing operations detected and identified by a separate monitoring computer system, potentially at a remote location.

### Example Methods

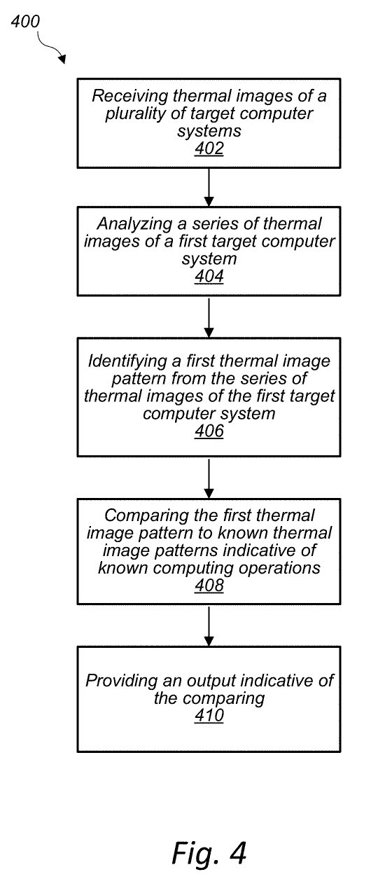

Referring now to FIG. 4, a flow diagram is shown of an example method 400 for detecting computing operations using thermal sensing, according to some embodiments. In various embodiments, method 400 may be implemented, for example, by monitoring computer system 102 of FIG. 1. FIG. 4 includes steps 402-410. Step 402 includes receiving thermal images of a plurality of target computer systems. For example, in some embodiments, monitoring computer system 102 may receive thermal images of a plurality of target computer systems 108 operating in a datacenter facility. Further, in some embodiments, the thermal images may be captured during a time period associated with a change in thermal characteristics of the plurality of computer systems.

Method 400 then proceeds to step 404, which includes analyzing a series of thermal images of a first target computer system. In the embodiment depicted in FIG. 2, for example, thermal image analysis module 204 may be configured to analyze the captured thermal image data 202, which may include the series of thermal images of the first target computer system. In some embodiments, the thermal images of the plurality of target computer system may be captured while the plurality of target computer systems were operating in an idle state.

Method 400 then proceeds to step 406, which includes identifying a first thermal image pattern from the series of thermal images of the first target computer system. For example, as depicted in FIG. 2, thermal image analysis module 204 may be configured to identify one or more thermal image patterns included in the captured thermal image data 202. These thermal image patterns may correspond, in some embodiments, to patterns in the change in distribution and intensity of heat captured in the thermal images of target computer system 108.

Method 400 then proceeds to step 408, which includes comparing the first thermal image pattern to known thermal image patterns indicative of known computing operations. For example, in some embodiments, the first computer system may compare the first thermal image pattern to one or more thermal image patterns included in thermal image patterns 350 of FIG. 3B. As discussed above, these known thermal image patterns may be indicative of known malicious computing operations or known benign computing operations, or both.

Method 400 then proceeds to step 410, which includes providing an output indicative of the comparing. For example, in some embodiments, the output may indicate that the first thermal image pattern corresponds to benign activity on target computer system, potential malicious activity on target computer system, or known malicious activity on target computer system.

Further, in some embodiments, method 400 may include determining, for example by the first computer system, whether the first thermal image pattern indicates that the first target computer system is performing computer operations other than those associated with an idle state. In some embodiments, the determining may include comparing a level of activity indicated by the first thermal image pattern to a threshold level of activity associated with a non-idle state. As noted above, the temperature of various components of a computer system may vary as it performs computing operations. As will be appreciated by those of skill in the art with the benefit of this disclosure, a computer system that is performing more computing operations, and particularly computationally-intensive computing operations, may, in some embodiments, generate more heat than a computer system performing fewer computing operations, such as one operating in an idle state, for example. Accordingly, in some embodiments, a level of activity of a target computer system may be indicated by an average temperature, or a pattern of average temperatures, of the target computer system, as indicated by the thermal image pattern. In some embodiments, data indicative of a threshold level of activity associated with an idle state may be stored, for example, as part of thermal image patterns 350 in FIG. 3B. Thus, in some embodiments, the determining whether the first thermal image pattern indicates that the first computer system is performing computing operations other than those associated with an idle state may include comparing a level of activity indicated by the first thermal image pattern to a threshold level of activity associated with an idle state. Further, in some embodiments, the determining may include comparing the first thermal image pattern to known thermal image patterns indicative of known benign computing operations, such as those included in known benign operations data 354 of FIG. 3B.

Note that, although method 400 has been described in the context of a first computer system detecting computing operations being performed on a separate target computer system, in some embodiments, the first computer system may be the target computer system. In such embodiments, the first computer system may be configured to detect the computing operations that it is performing using thermal sensing. As noted above, in various embodiments it may be desirable for the monitoring computer system to be separate from the target computer system. In some embodiments, however, it may be advantageous for the target computer system to monitor itself using thermal sensing. For example, although a computer virus may be configured to conceal its presence from anti-malware software, it may not be configured to conceal itself from detection by thermal sensing. Thus, in such embodiments, the disclosed systems and methods may be used to detect malicious computing operations on a target computer system acting as its own monitoring system, without the requirement of having a second, separate computer system.

Turning now to FIG. 5, a flow diagram is shown of an example method 500 for detecting computing operations on a target computer system based on thermal sensing, according to some embodiments. In various embodiments, method 500 may be implemented, for example, as activity monitor 200 of FIG. 2. FIG. 5 includes steps 502-512. Step 502 includes comparing a first thermal image pattern to known thermal image patterns. For example, as shown in FIG. 2, activity monitor 200 may include comparator 208 configured to compare captured thermal image pattern data 205 with thermal image pattern data 206. In some embodiments, step 502 may include comparing the first thermal image pattern to thermal image pattern data corresponding to both known malicious computing operations and known benign computing operations.

Method 500 then proceeds to step 504, which includes determining whether a match is detected between the first thermal image pattern and any of the thermal image patterns associated with benign computing operations. In some embodiments, step 504 may include determining, for example by activity determination module 210 of FIG. 2, whether the first thermal image pattern matches any of the thermal images specified by known benign operation data 354 of FIG. 3B.

If a match between the first thermal image pattern and thermal image patterns associated with benign activities is detected at step 504, method 500 continues to step 506, which includes generating an indication of benign activity on the target computer. In some embodiments, this indication may specify information associated with the benign activity, such as an identification of the activity, a time period associated with its performance, or an identification of the target computer system associated with the benign activity.

If, however, no match is detected at step 504, method 500 continues to steps 508-512. As shown in FIG. 5, if no match is detected at step 504, method 500 may optionally continue to step 508, which includes generating an indication of potentially malicious activity on the target computer. For example, in some embodiments, it may be desirable to flag all activity that is not determined to match a benign activity at step 504 as potentially malicious, without comparing the first thermal image pattern to known thermal image patterns associated with known malicious activities. This may, in some embodiments, provide the advantage of preserving computational resources by comparing the first thermal image pattern with a smaller set of known thermal image patterns.

In other embodiments, however, if no match is detected at step 504, method 500 may continue to step 510, which includes determining whether a match is detected between the first thermal image pattern and any of the thermal image patterns associated with malicious activities. In some embodiments, step 510 may include determining, for example by activity determination module 210 of FIG. 2, whether the first thermal image pattern matches any of the thermal images specified by known malicious operation data 352 of FIG. 3B.

If a match between the first thermal image pattern and thermal image patterns associated with malicious activities is detected at step 510, method 500 continues to step 512, which includes generating an indication of malicious activity on the target computer system. In some embodiments, this indication may specify information associated with the benign activity, such as an identification of the activity, a time period associated with its performance, or an identification of the target computer system associated with the malicious activity.

If, however, no match is detected at step 510, method 500 continues to step 508, which, as noted above, includes generating an indication of potential malicious activity on the target computer. In such an embodiment, in which no match is detected at either of steps 504 or 510, this may indicate that the first thermal image pattern does not correspond to any known thermal image patterns. This, in turn, may indicate that the first thermal image pattern corresponds to an unknown, and potentially malicious, computing operation. Alternatively, this result may indicate that the first thermal image pattern corresponds to a benign computing operation for which there is not yet a known thermal image pattern.

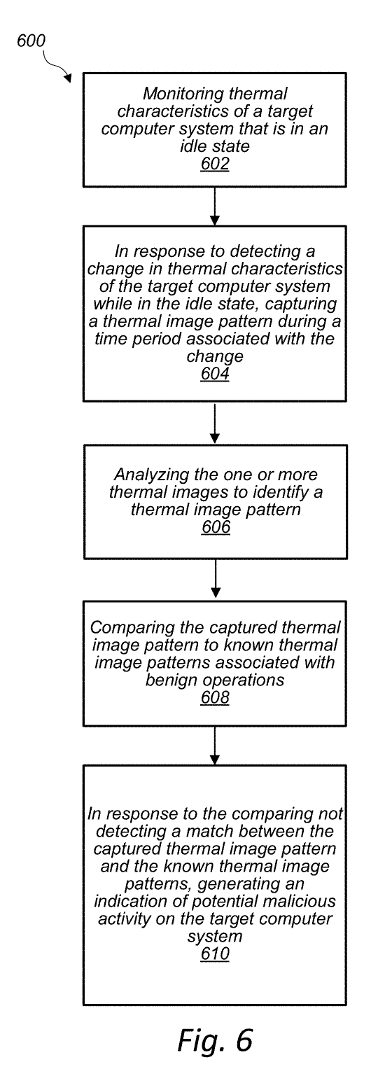

Referring now to FIG. 6, a flow diagram is shown of an example method 600 for detecting computing operations using thermal sensing, according to some embodiments. In various embodiments, method 600 may be implemented, for example, by monitoring computer system 102 of FIG. 1. FIG. 6 includes steps 602-610. Step 602 includes monitoring thermal characteristics of a target computer system that is in an idle state. In some embodiments, step 602 may include monitoring the intensity and distribution of thermal radiation emitted by target computer system 108 as it operates in an idle state.

Method 600 then proceeds to step 604, which includes, in response to detecting a change in thermal characteristics of the target computer system while in the idle state, capturing one or more thermal images of the target computer system during a time period associated with the change. For example, in some embodiments, the change in thermal characteristics of the target computer system may be characterized by an increase or decrease in the intensity of heat generated by target computer system 108, a shifting in the distribution of heat from one region to another region of target computer system 108, etc. In various embodiments, monitoring computer system 102 of FIG. 1 may capture a thermal image pattern using thermal imaging device 106 in response to detecting a change in thermal characteristics of the target computer system.

Method 600 then proceeds to step 606, which includes analyzing the one or more thermal images to identify a thermal image pattern. For example, as shown in FIG. 2, thermal image analysis module 204 may be configured to analyze the captured thermal image data 202, which may include the series of thermal images of the first target computer system.

Method 600 then proceeds to step 608, which includes comparing the captured thermal image pattern to known thermal image patterns associated with benign operations. In some embodiments, as explained above with reference to FIG. 5, step 608 may include determining, for example by activity determination module 210 of FIG. 2, whether the first thermal image pattern matches any of the thermal images specified by known benign operation data 354 of FIG. 3B.

Method 600 then proceeds to step 610, which includes, in response to the comparing not detecting a match between the thermal image pattern and the known thermal image patterns, generating an indication of potential malicious activity on the target computer system.

Additionally, in some embodiments, method 600 may further include monitoring, for example via thermal imaging device 106, the thermal characteristics of target computer system 108 that is in an idle state for a given period of time, such as two minutes, for example. In such embodiments, monitoring computer system 102 may be configured, in response to not detecting changes in the thermal characteristics of target computer system 108 during that given time period, to generate an output indicating that the target computer is not performing known malicious computing operations.

### Example Computer System

Turning now to FIG. 7, a block diagram of an example computer system 700, which may implement one or more computer systems, such as monitoring computer system 102 and/or target computer system 108 of FIG. 1, is depicted. Computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server system, personal computer system, desktop computer, laptop or notebook computer, mainframe computer system, server computer system operating in a datacenter facility, tablet computer, handheld computer, workstation, network computer, a consumer device such as a mobile phone, music player, or personal data assistant (PDA). Although a single computer system 700 is shown in FIG. 7 for convenience, computer system 700 may also be implemented as two or more computer systems operating together.

Processor subsystem 720 may include one or more processors or processing units. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is usable to store program instructions executable by processor subsystem 720 to cause system 700 perform various operations described herein. System memory 740 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as system memory 740. Rather, computer system 700 may also include other forms of storage such as cache memory in processor subsystem 720 and secondary storage on I/O Devices 770 (e.g., a hard drive, storage array, etc.). In some embodiments, these other forms of storage may also store program instructions executable by processor subsystem 720.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 770 includes a network interface device (e.g., configured to communicate over WiFi, Bluetooth, Ethernet, etc.), and computer system 700 is coupled to a network via the network interface device.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
monitoring, by a monitoring computer system using a thermal imaging device, thermal characteristics of a target computer system that is in an idle state;
in response to detecting a change in thermal characteristics of the target computer system while in the idle state, capturing, by the thermal imaging device, one or more thermal images of the target computer system during a time period associated with the change in thermal characteristics of the target computer system while in the idle state;
analyzing, by the monitoring computer system, the one or more thermal images to identify a thermal image pattern;
comparing, by the monitoring computer system, the thermal image pattern to known thermal image patterns associated with benign computing operations; and
in response to the comparing not detecting a match between the thermal image pattern and the known thermal image patterns, generating, by the monitoring computer system, an indication of potential malicious activity on the target computer system.

2. The method of claim 1, further comprising:
monitoring, by the monitoring computer system using the thermal imaging device, thermal characteristics of a second target computer system that is in an idle state;
in response to detecting a change in thermal characteristics of the second target computer system while in the idle state, capturing, by the thermal imaging device, a second thermal image pattern during a time period associated with the change;
comparing, by the monitoring computer system, the captured second thermal image pattern to known thermal image patterns associated with known malicious computer operations; and
based on the comparing the captured second thermal image pattern to known thermal image patterns associated with known malicious computer operations, generating, by the monitoring computer system, a second indication of potential malicious activity on the second target computer system.

3. The method of claim 2, further comprising:
determining, by the monitoring computer system based on the comparing the captured second thermal image pattern to known thermal image patterns associated with known malicious computer operations, that the captured second thermal image pattern indicates that the second target computer system is performing one or more of the known malicious computer operations; and
wherein the second indication specifies the one or more known malicious computer operations being performed by the second target computer system.

4. The method of claim 1, wherein the idle state includes an operating mode in which a particular set of automatic background operations on the target computer are disabled.

5. The method of claim 1, further comprising:
implementing a machine-learning procedure, including by:
receiving, by the monitoring computer system, an identification of a known computing operation associated with the thermal image pattern; and
storing, by the monitoring computer system, the thermal image pattern as a known thermal image pattern of a plurality of known thermal image patterns.

6. The method of claim 5, further comprising:
in response to detecting a second change in thermal characteristics of the target computer system while in the idle state, capturing, by the thermal imaging device, a second thermal image pattern during a time period associated with the second change;
comparing, by the monitoring computer system, the captured second thermal image pattern to the plurality of known thermal image patterns; and
in response to the comparing detecting a match between the captured second thermal image pattern and a particular one of the plurality of known thermal image patterns, generating, by the monitoring computer system, an output specifying a particular known computer operation.

7. The method of claim 1, wherein the monitoring further comprises:
monitoring, by the monitoring computer system using the thermal imaging device, thermal characteristics of a second target computer system that is in the idle state for a given period of time; and
in response to not detecting changes in the thermal characteristics of the second target computer system beyond a particular threshold during the given time period, generating, by the monitoring computer system, an output indicating that the target computer is not performing known malicious computing operations.

8. The method of claim 1, wherein the target computer system is one of a plurality of computer systems in a datacenter facility.

9. A non-transitory, computer-readable medium having instructions stored thereon that are executable by a first computer system to perform operations comprising:
receiving, by the first computer system, a series of thermal images of a target computer system, wherein the series of thermal images are captured during a time period associated with a change in thermal characteristics of the target computing system;
analyzing, by the first computer system, the series of thermal images to identify a thermal image pattern;
comparing, by the first computer system, the thermal image pattern to known thermal image patterns associated with benign computing workloads; and
based on the comparing, generating, by the first computer system, an indication of potential malicious activity on the target computer system.

10. The non-transitory, computer-readable medium of claim 9, wherein the operations further comprise:
prior to the receiving, sending, by the first computer system, one or more instructions to the target computer system, wherein the one or more instructions are operable to cause the target computer system to be put in an idle state.

11. The non-transitory, computer-readable medium of claim 10, wherein the one or more instructions that are operable to cause the target computer system to be put in an idle state are operable to disable tasks that are set to be run automatically on the target computer system.

12. The non-transitory, computer-readable medium of claim 11, wherein the thermal image pattern of the target computer system corresponds to computing operations being performed by the target computer system during the time period associated with the change in thermal characteristics.

13. The non-transitory, computer-readable medium of claim 9, wherein the generating, by the first computer system, the indication of potential malicious activity on the target computer system is in response to the comparing not detecting a match between the thermal image pattern of the target computer system and the known thermal image patterns associated with benign computing workloads.

14. The non-transitory, computer-readable medium of claim 9, wherein the operations further comprise:
comparing, by the first computer system, the thermal image pattern to known thermal image patterns associated with known malicious computer operations; and
generating, by the first computer system, an indication of malicious activity on the target computer system is in response to:
the comparing not detecting a match between the thermal image pattern of the target computer system and the known thermal image patterns associated with benign computing workloads; and
detecting a match between the thermal image pattern of the target computer and the known thermal image patterns associated with known malicious computer operations.

15. A method, comprising:
receiving, by a first computer system, thermal images of a plurality of target computer systems operating in a datacenter facility;
analyzing, by the first computer system, a series of thermal images of a first target computer system of the plurality of target computer systems;
identifying, by the first computer system based on the analyzing, a first thermal image pattern from the series of thermal images of the first target computer system;
comparing, by the first computer system, the first thermal image pattern to known thermal image patterns indicative of known computing operations; and
providing, by the first computer system, an output indicative of the comparing.

16. The method of claim 15, wherein the thermal images of the plurality of computer systems are captured while the plurality of computer systems are operating in an idle state.

17. The method of claim 15, further comprising:
determining, by the first computer system, whether the first thermal image pattern indicates that the first target computer system is performing computing operations other than those associated with an idle state.

18. The method of claim 17, wherein the determining comprises:
comparing, by the first computer system, a level of activity indicated by the first thermal image pattern to a threshold level of activity associated with the idle state.

19. The method of claim 17, wherein the determining comprises:
comparing, by the first computer system, the first thermal image pattern to known thermal image patterns indicative of known benign computing operations.

20. The method of claim 15, wherein the first computer system is the first target computer system.
